(19) United States
(12) Patent Application Publication
(10) Pub. No.: US 2021/0363937 A1
(43) Pub. Date: Nov. 25, 2021

(54) INJECTOR CONTROL DEVICE

(71) Applicant: Hitachi Automotive Systems, Ltd., Hitachinaka-shi, Ibaraki (JP)

(72) Inventors: Ryo KUSAKABE, Tokyo (JP); Akiyasu MIYAMOTO, Tokyo (JP); Yoshihiro SUKEGAWA, Tokyo (JP); Masayuki SARUWATARI, Tokyo (JP)

(73) Assignee: Hitachi Automotive Systems, Ltd., Hitachinaka-shi, Ibaraki (JP)

(21) Appl. No.: 17/057,272

(22) PCT Filed: Feb. 13, 2019
(86) PCT No.: PCT/JP2019/004952

§ 371 Date: Nov. 20, 2020

(30) Foreign Application Priority Data
May 24, 2018 (JP) 2018-099474

(51) Int. Cl. F02D 41/40; F02D 41/20

(52) U.S. Cl. CPC F02D 41/402; F02D 2041/2027; F02D 41/20

(57) ABSTRACT

In an internal combustion engine, combustion stability is improved while exhaust gas emission is suppressed. For this purpose, a control device (1) for controlling an injector (103) is configured to include a control unit (21) that controls the injector (103) to perform a first fuel injection (1001) for injecting fuel at a first fuel pressure from the injector (103) in an intake stroke (S1) in one combustion cycle of an internal combustion engine (100) and a second fuel injection (1002) for injecting fuel at a second fuel pressure higher than the first fuel pressure from the injector (103) after the first fuel injection (1001) in the same one combustion cycle in the intake stroke (S1).

### TECHNICAL FIELD

The present invention relates to an injector control device.

### BACKGROUND ART

In recent years, from the viewpoint of preventing global warming and inhibiting depletion of resources such as fossil fuels, improvement in fuel consumption and reduction of carbon dioxide (CO2) have been demanded in internal combustion engines of mobile objects. In order to reduce the carbon dioxide emitted from the internal combustion engine, it is necessary to reduce the amount of fuel consumed. In this regard, lean combustion is an effective technique, in which fuel is burned in a lean air-fuel mixture condition. In this lean combustion state, since it is necessary to ignite the air-fuel mixture having a small equivalence ratio (a value indicating a fuel concentration) in a cylinder, the combustion becomes slow and tends to become unstable. Accordingly, in this type of internal combustion engine of a mobile object, as a method of stabilizing the combustion in the lean combustion state, there is available a method (to be sometimes referred to as weak stratified combustion) of stabilizing combustion by injecting a small amount of fuel during a compression stroke period in one combustion cycle and setting the atmosphere near the ignition plug to a slightly high fuel concentration state (to be sometimes referred to as a fuel rich state hereinafter).

In addition, in the internal combustion engine of a mobile object, with the strengthening of exhaust gas regulations, it is required to reduce the total amount of unburned particles (Particulate Matter: PM), the number of unburned particles (Particulate Number: PN), hydrocarbon (HC), and nitrogen oxide (N0x).

PN and HC are generated when the fuel injected from the injector of the internal combustion engine adheres to the piston and bore wall surface in the cylinder. Further, PN tends to increase when the equivalence ratio, which is the ratio of air to fuel in an air-fuel mixture in the cylinder, is large, that is, when there is a rich fuel region. Therefore, in the internal combustion engine, in order to suppress the generation of PN and HC, it is necessary to reduce the amount of fuel adhering to the piston and the bore wall surface in the cylinder.

Further, a large amount of HC is emitted at the time of starting the internal combustion engine in which a catalyst provided on the exhaust side of the internal combustion engine is not activated. Accordingly, in the internal combustion engine, the exhaust loss can be increased and the temperature of the exhaust gas can be increased by retarding the ignition timing more than during idling after the completion of warming up, and the emission of HC can be suppressed by raising the temperature of the catalyst early. In the method of retarding the ignition timing, the compression stroke in one combustion cycle of the internal combustion engine ends, and the piston ignites in the expansion stroke from top dead center to bottom dead center. Consequently, combustion tends to become unstable. Accordingly, in the method of retarding the ignition timing, in order to reliably ignite the fuel, a technique is required, which forms a fuel rich air-fuel mixture necessary for ignition around the ignition plug provided in the internal combustion engine. At the ignition timing of the ignition plug, in order to form a fuel rich air-fuel mixture around the ignition plug, a fuel rich air-fuel mixture can be collected around the ignition plug by forming a cavity (recess) in the crown surface of the piston and blowing up the gas mixture supplied in the cavity in the crown surface in the direction of the ignition plug by injecting fuel in the compression stroke.

In this case, in order to inject fuel into the cavity formed in the crown surface of the piston and blow up a fuel rich air-fuel mixture around the ignition plug, it is necessary to increase the penetration of fuel injected from the injector (the reach of fuel spray) (increase the penetration force) to increase the amount of the air-fuel mixture blown up from the cavity so as to reliably make the air-fuel mixture reach the ignition plug.

On the other hand, in the intake stroke in one combustion cycle of the internal combustion engine, from the viewpoint of promoting the mixing of air and fuel, it is required to increase the injection time of the fuel injected from the injector. There are different requests for injection by the injector in the intake stroke and the compression stroke.

Patent Literature 1 discloses a method of changing the injection state of fuel injected from an injector depending on an intake stroke and a compression stroke in one combustion cycle of an internal combustion engine. In the injector control method disclosed in Patent Literature 1, in the intake stroke in one combustion cycle of the internal combustion engine, the injection pulse of the fuel injected from the injector is lengthened, whereas in the compression stroke in one combustion cycle of the internal combustion engine, the injection pulse of the fuel injected from the injector is shortened. This method performs this injection pattern a plurality of times to change the injection state between an intake stroke and a compression stroke.

### CITATION LIST

### Patent Literature

PTL 1: JP 2015-183617 A

### SUMMARY OF INVENTION

### Technical Problem

However, in this type of internal combustion engine, when warming up the catalyst after the internal combustion engine is started, it is necessary to form a fuel rich air- fuel mixture necessary for combustion stability around the ignition plug and to inject fuel in the compression stroke in one combustion cycle. In particular, when the injector is of a side-injection type that is attached to a side surface of the combustion chamber, the distance between the injector and the ignition plug is large. Accordingly, at a predetermined ignition timing, in order to form a fuel rich air-fuel mixture around the ignition plug, it is necessary to increase the amount of fuel injected in the compression stroke. On the other hand, in the compression stroke in one combustion cycle of the internal combustion engine, the distance between the injector and the crown surface of the piston becomes short. This poses a problem that the fuel injected from the injector tends to adhere to the piston, and the amounts of HC and PN generated increase.

Further, in the intake stroke in one combustion cycle when warming up the catalyst, there is a demand to increase the injection time of the fuel injected from the injector from the viewpoint of enhancing the homogeneity of air and fuel. On the other hand, when the catalyst is warmed up, the temperature of a cylinder wall surface after starting the internal combustion engine is low. Accordingly, in some cases, the fuel injected in the intake stroke adheres to the cylinder wall surface and the amounts of HC and PN generated increase, resulting in deterioration in the homogeneity between air and fuel.

Therefore, the present invention has an object to provide an injector control device capable of enhancing the homogeneity of the air-fuel mixture in the intake stroke in one combustion cycle of an internal combustion engine and ensuring combustion stability while reducing the exhaust gas emission in the compression stroke.

### Solution to Problem

To solve the above problem, a control device for controlling an injector includes a control unit that controls the injector to perform a first fuel injection for injecting fuel at a first fuel pressure from the injector in an intake stroke in one combustion cycle of an internal combustion engine and a second fuel injection for injecting fuel at a second fuel pressure higher than the first fuel pressure from the injector after the first fuel injection in the same one combustion cycle in the intake stroke.

### Advantageous Effects of Invention

According to the present invention, in an internal combustion engine, combustion stability can be improved while exhaust gas emission is suppressed.

### BRIEF DESCRIPTION OF DRAWINGS

FIG. 1 is a schematic diagram illustrating a fuel injection system constituted by a control device, an injector, and a pressure sensor.

FIG. 2 is a cross-sectional view illustrating the structure of the injector and an example of the configuration of the control device for driving the injector.

FIG. 3 is an enlarged view of a portion A of FIG. 2.

FIG. 4 is a view showing over time the relationship between a fuel control signal output from an ECU, a drive voltage of the solenoid of an injector, a drive current, and the displacement amount of a valve body.

FIG. 5 is a view illustrating the state in which fuel is injected from the injector into the cylinder in the internal combustion engine.

FIG. 6 is a schematic diagram illustrating the main part of the system configuration of the internal combustion engine.

FIG. 7 is a view illustrating the relationship between the crank angle, the lift amount of an intake valve and the turbulent velocity in the cylinder.

FIG. 8 is a projection view of fuel injected from the injector when the direction of the injector is viewed from a cross-section - A of FIG. 5.

FIG. 9 is a view illustrating the changes over time of the pulse width of a fuel control signal output from the control device, a drive current, and a valve body displacement amount.

FIG. 10 is a view illustrating the state of the fuel injected from the injector in a compression stroke.

FIG. 11 is a cross-sectional view illustrating the structure of an injector according to the second embodiment.

FIG. 12 is an enlarged view of the vicinity of a mover mechanism, showing a state in which the mover mechanism is pressed by a first spring in the fuel injection hole direction.

FIG. 13 is an enlarged view of the vicinity of the mover mechanism, showing a short stroke state in which a second mover of the mover mechanism is attracted by the solenoid.

FIG. 14 is an enlarged view of the vicinity of the mover mechanism, showing a long stroke state in which the first mover and the second mover are attracted by the solenoid.

FIG. 15 is a view illustrating an example of the drive current supplied to the solenoid of the injector.

FIG. 16 is a view illustrating an example of the relation between a fuel control signal and a fuel injection quantity.

FIG. 17 is a view showing the relationship over time between a fuel control signal, a drive current, and the displacement amount of a valve body according to the second embodiment.

### DESCRIPTION OF EMBODIMENTS

Embodiments of the present invention will be described in detail below reference to the accompanying drawings.

### First Embodiment

An injector control device (to be referred to as a control device 1 hereinafter) according to the first embodiment of the present invention will be described first. This embodiment will exemplify a case in which the control device 1 is applied to the control of injectors 103 to 106 provided in the in-line four-cylinder piston internal combustion engine for a vehicle.

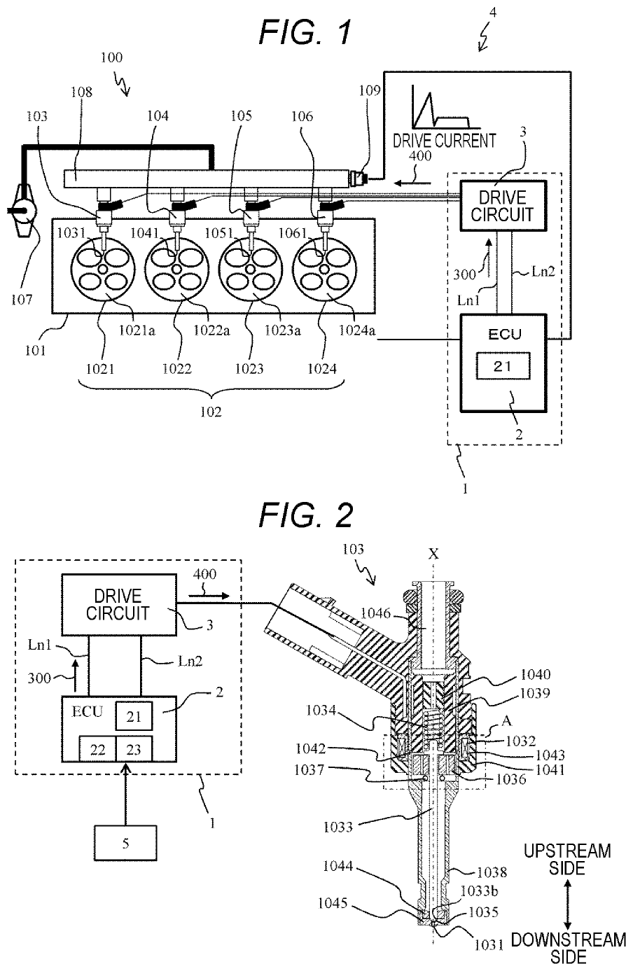

FIG. 1 is a schematic diagram illustrating a fuel injection system 4 constituted by the control device 1, the injectors 103 to 106, and a pressure sensor 3.

As shown in FIG. 1, in the in-line four-cylinder piston type internal combustion engine (to be referred to as an internal combustion engine 100 hereinafter), four cylinders (to be referred to as cylinders 102 hereinafter) are arranged in a row in a cylinder block 101. In the embodiment, the cylinders 102 include a first cylinder 1021, a second cylinder 1022, a third cylinder 1023, and a fourth cylinder 1024 arranged in the order named from the left side of FIG. 1, and the cylinders 1021 to 1024 are respectively provided with injectors 103, 104, 105, and 106 (to be also referred to as fuel injection devices). Fuel injection holes 1031 to 1061 provided on the respective distal end sides of the injectors 103 to 106 are located in combustion chambers 1021a to 1024a of the respective cylinders 1021 to 1024, and the fuel injected from the fuel injection holes 1031 to 1061 of the injectors 103 to 106 is directly injected into the combustion chambers 1021a to 1024a. The fuel is boosted by a fuel pump 107, delivered to a rail pipe 108 (fuel pipe), and then supplied to each of the injectors 103 to 106. The fuel pressure (to be referred to as the fuel pressure hereinafter) varies depending on the balance between the flow rate of fuel discharged by the fuel pump 107 and the injection amount of fuel injected into the respective combustion chambers 1021a to 1024a by the injectors 103 to 106 respectively provided in the cylinders 1021 to 1024. The amount of fuel discharged from the fuel pump 107 is controlled by setting a predetermined pressure as a target value based on information from a pressure sensor 109 provided for the rail pipe 108.

The pressure (fuel pressure) and injection amount of fuel injected from the injectors 103 to 106 are controlled by the pulse of a fuel control signal 300 output from a control unit 21 of an engine control unit (ECU) 2. The fuel control signal 300 output from the control unit 21 of the ECU 2 is input to a drive circuit 3 that drives the injectors 103 to 106. The drive circuit 3 generates the waveform of a drive current 400 for driving the injectors 103 to 106 based on the fuel control signal 300 output from the control unit 21, and supplies the drive current 400 to the injectors 103 to 106 for a time corresponding to the pulse width of the fuel control signal 300. The embodiment exemplifies the case in which the ECU 2 and the drive circuit 3 are divided as separate components and connected to each other via a signal line Ln1 and a communication line Ln2. The drive circuit 3 may be mounted as a component or board integrated with the ECU 2.

In the embodiment, the ECU 2 and the drive circuit 3 provided integrally or separately are collectively referred to as the control device 1.

### Injector

The structure and basic operation of the injectors 103 to 106 will be described next. Hereinafter, the structure of the injector 103 described above will be exemplified, but since the other injectors 104 to 106 also have the same structure, a detailed description thereof will be omitted.

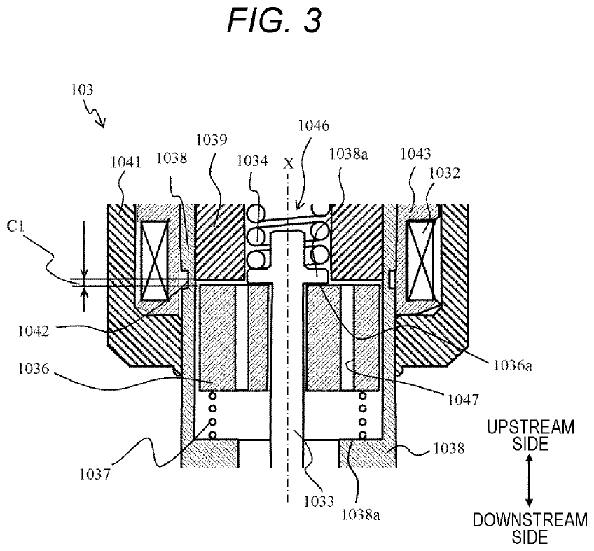

FIG. 2 is a cross-sectional view illustrating the structure of the injector 103 and an example of the configuration of the control device 1 for driving the injector 103. FIG. 3 is an enlarged view of a portion A in FIG. 2. Referring to FIGS. 2 and 3, the upper side in the each drawing is defined as the upstream side in the fuel flow direction, and the lower side is defined as the downstream side in the fuel flow direction.

As shown in FIG. 2, the control unit 21 of the ECU 2 takes in signals indicating the operating state of the internal combustion engine 100 from various types of sensors 5, and calculates the pulse width of the fuel control signal 300 for controlling the amount of fuel injected from the injector 103 and the injection timing in accordance with the operating state of the internal combustion engine 100. The ECU 2 also includes an analog-to-digital (A/D) converter 22 for taking in signals from the various types of sensors 5 and an input/output (I/O) port 23. The fuel control signal 300 output from the control unit 21 is input to the drive circuit 3 via the signal line Ln1.

The drive circuit 3 generates the drive current 400 for generating a drive voltage 500 applied to the solenoid 1032 of the injector 103 based on the fuel control signal 300. The control unit 21 communicates with the drive circuit 3 via the communication line Ln2, and can change the drive current 400 and the set value of the drive time by switching the drive current 400 generated by the drive circuit 3 depending on the pressure of fuel supplied to the injector 103 and the operating state of the internal combustion engine 100.

The injector 103 is a closed solenoid valve (electromagnetic fuel injection device) in which the fuel injection hole 1031 is closed when the drive voltage 500 is not applied to a solenoid 1032 (in normal times). That is, when the drive voltage 500 is not applied to the solenoid 1032, a valve body 1033 is biased in the closing direction (downstream side in FIG. 2) by a spring 1034, and the valve body 1033 and a valve seat 1035 come into close contact with each other to close the valve. When the injector 103 is in the valve closed state, the biasing force of a return spring 1037 in the opening direction (upstream side in FIG. 2) acts on a mover 1036. In this case, since the downstream biasing force of the spring 1034 that biases the valve body 1033 is larger than the upstream biasing force of the return spring 1037, an end face 1036a of the mover 1036 comes into contact with the valve body 1033 to restrict the movement of the mover 1036 in the axis X direction (see FIG. 3). Further, the valve body 1033 and the mover 1036 are configured to be capable of relative displacement, and are contained in a nozzle holder 1038. As shown in FIG. 3, the nozzle holder 1038 has an end face 1038a that serves as a spring seat for the return spring 1037. The biasing force to the downstream side by the spring 1034 is adjusted at the time of assembly by the pushing amount of a spring retainer 1040 (see FIG. 2) fixed to the inner diameter side of a fixed core 1039.

As shown in FIG. 3, in the injector 103, the fixed core 1039, the mover 1036, the nozzle holder 1038, and a housing 1041 constitute a magnetic circuit, and a gap Cl is formed between the mover 1036 and the fixed core 1039. A magnetic diaphragm 1042 is formed in a portion of the nozzle holder 1038 which corresponds to the gap Cl between the mover 1036 and the fixed core 1039. The solenoid 1032 is attached to the outer peripheral side of the nozzle holder 1038 while being wound around a bobbin 1043. As shown in FIG. 2, a rod guide 1044 is fixed to the nozzle holder 1038 near the distal end portion of the valve body 1033 on the valve seat 1035 side. The valve body 1033 is guided by the spring seat (not shown) of the valve body 1033 and a rod guide 1044 so as to be slidable in the axis X direction. An orifice 1045 in which the valve seat 1035 and the fuel injection hole 1031 are formed is provided at the distal end portion of the nozzle holder 1038, and an internal space (fuel passage) provided between the mover 1036 and the valve body 1033 is sealed from the outside.

The fuel supplied to the injector 103 is supplied from the rail pipe 108 (see FIG. 1) provided on the upstream side of the injector 103 in the fuel flow direction, flows to the distal end side of the valve body 1033 through a lower fuel passage hole 1047 provided in a first fuel passage hole 1046 and the mover 1036, and is sealed by a seat portion 1033b and the valve seat 1035 formed at the end portion of the valve body 1033 on the valve seat 1035 side. In the injector 103, when the valve is closed, a pressure difference (differential pressure) between the upper portion and the lower portion of the valve body 1033 is generated due to the fuel pressure, and the valve body 1033 is pressed in the valve closing direction by the pressure difference obtained by multiplying the fuel pressure by the pressure receiving area of the seat inner diameter at the valve seat position and the load of the spring 1034. When a current is supplied to the solenoid 1032 from the valve closed state, a magnetic field is generated in the magnetic circuit, a magnetic flux passes between the fixed core 1039 and the mover 1036, and a magnetic attraction force acts on the mover 1036. At a timing when the magnetic attraction force acting on the mover 1036 exceeds the differential pressure and the biasing force of the spring 1034 to the downstream side, the mover 1036 starts displacement toward the fixed core 1039 along the axis X (starts opening the valve).

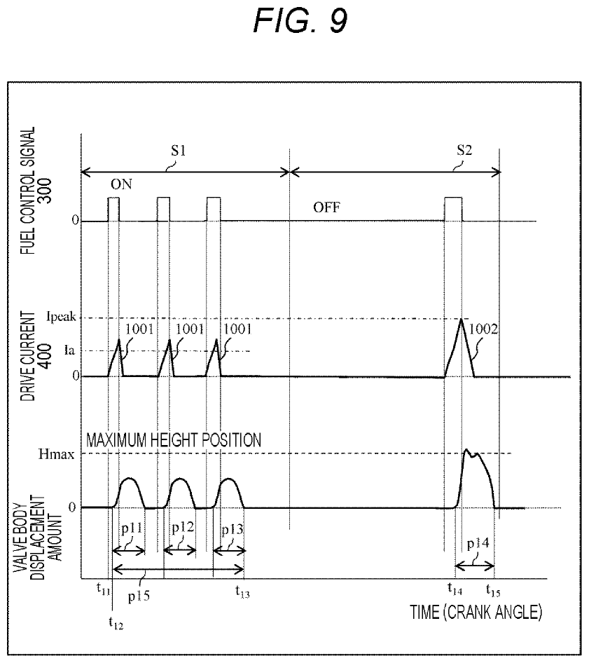

The mover 1036 and the fixed core 1039 that have completed the valve closing operation in this way stand still in the valve open state. In the valve open state of the injector 103, there is a gap for storing fuel between the valve body 1033 and the valve seat 1035, and the fuel stored in this gap is injected into the cylinder 1021 through the fuel injection hole 1031. In this case, the fuel pressure of the fuel injected from the injector 103 is determined by the fuel pressure supplied from the rail pipe 108, the displacement amount of the valve body 1033 of the injector 103 (the area of the fuel passage), and the like. Assuming that the fuel pressure supplied from the rail pipe 108 does not fluctuate or slight fluctuates, the fuel pressure is determined by the displacement amount of the valve body 1033 of the injector 103. More specifically, when the displacement amount of the valve body 1033 is small, the flow rate of the fuel flowing through the fuel injection hole 1031 per unit time decreases. As a result, when the fuel pressure of the fuel injected from the injector 1033 decreases and the displacement amount of the valve body 1033 is large, the amount of fuel flowing through the fuel injection hole 1031 increases, and as a result, the fuel pressure of the fuel injected from the injector 103 increases (see FIG. 9). In this case, the flow rate of fuel per unit time refers to the flow rate of fuel injected per unit time during the valve opening period of the valve body 1033.

That is, the flow rate of fuel per unit time means the fuel injection rate represented by the gradient in the graph with the ordinate representing the injection amount of fuel injected from the injector 103 and the abscissa representing the time.

When the drive current 400 supplied to the solenoid 1032 is cut off, the magnetic flux generated in the magnetic circuit disappears, and the magnetic attraction force acting on the mover 1036 also disappears. As a result, the mover 1036 and the valve body 1033 are pushed back to the valve closing position where they are in contact with the valve seat 1035 due to the load of the spring 1034 and the pressure difference to close the valve.

### Valve Body Drive Method

Described next is the relationship between the fuel control signal 300 output from the control unit 21 of the ECU 2 according to the embodiment of the present invention, the drive voltage 500 applied to the solenoid 1032 of the injector 103, the drive current 400, and the displacement amount of the valve body 1033 (the behavior of the valve body 1033).

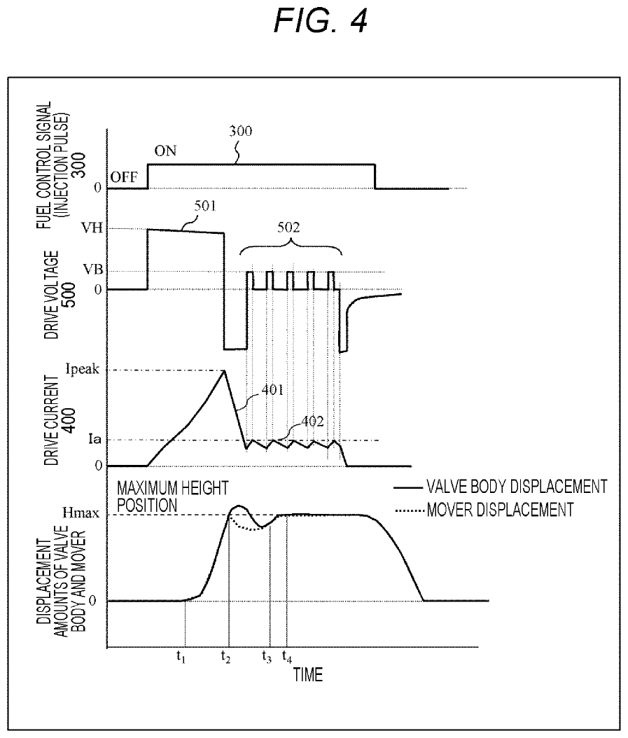

FIG. 4 is a view illustrating the fuel control signal 300 output from the ECU 2, the drive voltage 500 applied to the solenoid 1032 of the injector 103, the drive current 400, and the displacement amount of the valve body 1033 (the behavior of the valve body).

The uppermost plot of FIG. 4 is an example of the fuel control signal 300 (injection pulse) output from the control unit 21 of the ECU 2 to the drive circuit 3. The fuel control signal 300 is an ON/OFF signal and is turned on for a predetermined time when driving the injector 103. The second uppermost plot of FIG. 4 is an example of the waveform of the drive voltage 500 generated by the drive circuit 3 based on the fuel control signal 300 output from the control unit 21. The drive voltage 500 generated by the drive circuit 3 includes a high voltage 501 boosted to a voltage VH higher than a battery voltage VB to rapidly increase the drive current 400 supplied to the solenoid 1032 in a short time to open the valve body 1033 and a holding voltage 502 configured such that a drive voltage is turned on and off to perform intended duty control to perform control to hold the valve body 1033 in the open state. The third uppermost plot of FIG. 4 is an example of the waveform of the drive current 400 flowing through the solenoid 1032 by the drive voltage 500 generated by the drive circuit 3. The drive current 400 flowing through the solenoid 1032 reaches a peak current value Ipeak by applying the high voltage 501 and then sharply decreases as the application of the drive voltage 500 is stopped (drive current 401). The drive current 400 is held at a substantially constant current value Ia by the holding voltage 502 of the drive voltage 500 (holding current 402). The lowermost plot of FIG. 4 is an example of the displacement amounts of the valve body 1033 of the injector 103 and the mover 1036. The valve body 1033 starts displacement (valve opening) after a slight time lag as the drive current 400 flowing through the solenoid 1032 increases, and is displaced to a position exceeding a maximum height position Hmax after the drive current 400 reaches the peak current value Ipeak. Subsequently, the valve body 1033 becomes smaller in displacement from a position exceeding the maximum height position Hmax to a position less than the maximum height position Hmax in accordance with the abrupt decrease of the drive current 400, and the holding current 402 of the drive current 400 holds the valve body 1033 at a predetermined height position that is the maximum height position Hmax. On the other hand, the mover 1036 is displaced in a manner almost similar to the valve body 1033. After the valve body 1033 reaches the maximum height position Hmax (time t2), the displacement amount temporarily decreases to a height position less than the maximum height position Hmax. Subsequently, the mover 1036 increases in displacement up to the same maximum height position Hmax as the valve body 1033, and then is held at a predetermined height position that is the maximum height position Hmax.

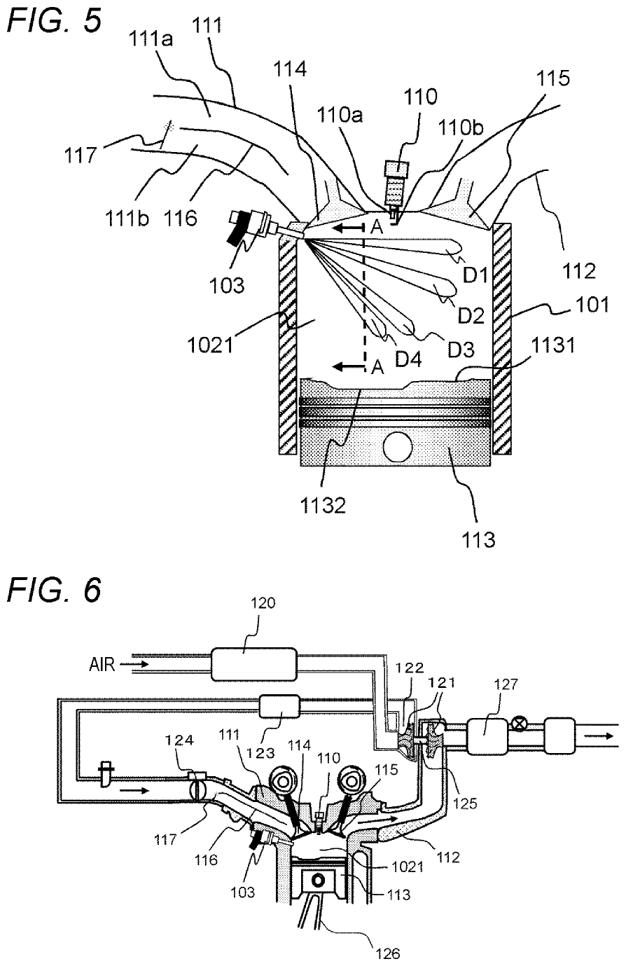

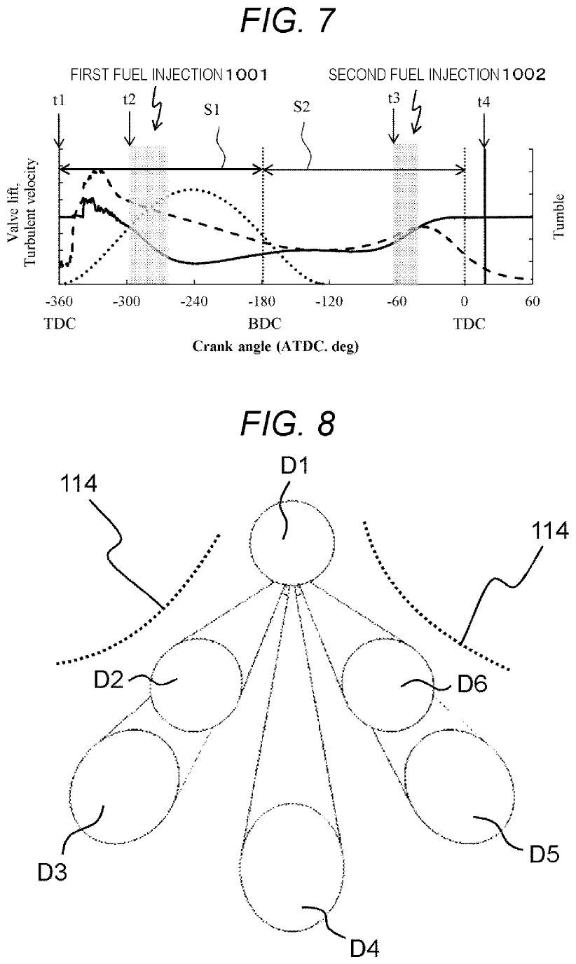

The configuration of the internal combustion engine 100 provided with the injector 103 according to the embodiment and the state of the fuel injected from the injector 103 will be described next. The embodiment will exemplify a direct injection internal combustion engine that directly injects fuel into the cylinder 1021. FIG. 5 is a view illustrating the state in which fuel is injected from the injector 103 into the cylinder 1021 in the internal combustion engine 100. FIG. 6 is a schematic diagram illustrating the main part of the system configuration of the internal combustion engine 100. FIG. 7 is a graph illustrating the relationship between the crank angle, the lift amount of an intake valve 114, and the turbulent velocity in the cylinder 1021. TDC and BDC in an intake stroke S1 respectively correspond to −360 deg and −180 deg, and TDC in a compression stroke S2 corresponds to Odeg. The lift amount of the intake valve 114 is indicated by the dotted line, the average value of the turbulent velocity in the cylinder 1021 is indicated by the broken line, and the tumble in the cylinder 1021 is indicated by the solid line.

The configuration of the internal combustion engine 100 including the injector 103, an ignition plug 110, an intake port 111, an exhaust port 112, a piston 113, the intake valve 114, and an exhaust valve 115 will be described with reference to FIG. 5.

A crown surface 1131 of the piston 113 which is located on the ignition plug 110 side has a cavity 1132 formed so as to be lower than the upper end face of the piston 113 which is located on the ignition plug 110 side. The cavity 1132 has a function of holding the air-fuel mixture obtained by mixing the fuel injected from the injector 103 with air. The intake port 111 is provided with a fixed partition 116 that blocks the flow of air from an upper portion 111a to a lower portion 111b of the intake port 111, and a valve 117 whose opening and closing is controlled by the ECU 2 is provided upstream of this partition 116.

In the embodiment, the valve 117 in the closed state is shown.

The main part of the system configuration of the internal combustion engine 100 will be described next with reference to FIG. 6. The following will exemplify the configuration related to the cylinder 1021. Since the configuration related to each of the remaining cylinders 1022 to 1024 is the same, a detailed description will be omitted.

In the internal combustion engine 100, the air taken from the outside air is supplied to the cylinder 1021 through an air cleaner 120, a supercharging chamber 122 provided with superchargers 121, an intercooler 123, a throttle valve 124, and the intake port 111. The air cleaner 120 provided at the air intake port removes dust and dirt contained in air and prevents the dust and the like from entering the internal combustion engine 100, thereby suppressing internal wear of the internal combustion engine 100. The supercharging chamber 122 is provided with the superchargers 121 (turbines) on the intake side and the exhaust side of air, and the superchargers 121 on the intake side and exhaust side are connected to each other via a shaft 125.

Accordingly, the supercharger 121 on the intake side also rotates accompanying the rotation of the supercharger 121 on the exhaust side in accordance with the flow velocity of the exhaust gas flowing through the exhaust port 112. The rotation of the supercharger 121 on the intake side can increase the amount of air flowing into the cylinder 1021, and hence can increase the output of the internal combustion engine 100. Further, the temperature of air flowing through the supercharging chamber 122 rises due to supercharging by the supercharger 121. After the air is cooled by the intercooler 123, therefore, the air flows into the cylinder 1021 through the throttle valve 124 for adjusting the amount of air flowing into the cylinder 1021 and the intake port 111. In the cylinder 1021, the air-fuel mixture obtained by mixing fuel and air is ignited by the ignition plug 110, and the drive force obtained by combustion is transmitted to a crankshaft 126. Thereafter, the exhaust valve 115 is opened in the expansion stroke to rotate the supercharger 121 on the exhaust side at the flow velocity of the exhaust gas exhausted from the exhaust port 112. Subsequently, hydrocarbons (HC), nitrogen oxides (NOx), and carbon monoxide (CO) contained in the exhaust gas are removed by being reduced and oxidized by palladium, rhodium, platinum, and the like constituting a catalyst 127 when passing through the catalyst 127. However, when the temperature of the catalyst 127 is low, the reducing ability of HC or the like by palladium or the like is low, so that the catalyst 127 needs to be warmed up early especially under conditions, for example, at the time of starting the internal combustion engine 100.

An example of fuel injection control under the warm-up conditions for the catalyst 127 will be described with reference to FIG. 7. Under the warm-up conditions for the catalyst 127, the opening of the intake valve 114 is started to take in air into the combustion chamber at a timing t1 when the piston 113 reaches the top dead center (TDC) and immediately before or at the same time when the exhaust valve 115 opens. At a timing t2 when the intake valve 114 starts opening and reaches the maximum lift amount, the injector 103 performs fuel injection in the intake stroke S1 (first fuel injection 1001). In the compression stroke S2 after the piston 113 reaches the bottom dead center (BDC) from TDC, at a timing t3 before the piston 113 reaches TDC from BDC, fuel injection from the injector 103 in the compression stroke S2 (second fuel injection 1002) is performed.

As a result, in the compression stroke S2 in which the piston 113 approaches the ignition plug 110, the air-fuel mixture obtained by mixing fuel injected from the injector 103 with air is put into the cavity 1132 of the crown surface 1131 of the piston 113. The air-fuel mixture put in the cavity 1132 during movement of the piston 113 to TDC is blown up toward the ignition plug 110. This can form a fuel rich air-fuel mixture that is fuel richer than the stoichiometric air-fuel ratio (to be sometimes referred to as the stoichiometric hereinafter) around the ignition plug 110. The control unit 21 of the ECU 2 controls the injector 103 to inject fuel from the injector 103 at predetermined injection timings t2 and t3 in the intake stroke S1 and the compression stroke S2 described above. At this time, the ratio (split ratio) of the fuel injected in the intake stroke S1 and the fuel injected in the compression stroke S2 is set to be larger in the intake stroke S1, and is preferably set to, for example, about 6:4, 7:3, or 8:2.

In the internal combustion engine 100, at a timing t4 when a fuel rich air-fuel mixture is formed around a minus electrode 110b and a plus electrode 110a (see FIG. 5) of the ignition plug 110, ignition is performed by the ignition plug 110 and the air-fuel mixture is ignited and burnt. At the timing t4, in order to secure a fuel rich air-fuel mixture around the ignition plug 110, it is necessary to increase the amount of fuel injected from the injector 103 in the compression stroke S2. In the compression stroke S2, since the distance between the injector 103 and the piston 113 is short, if a large amount of fuel is injected from the injector 103, the injected fuel may adhere to the piston 113 to increase HC or PN of the exhaust gas. Accordingly, the control unit 21 controls the injector 103 so that the amount of fuel injected in the second fuel injection 1002 in the compression stroke S2 is smaller than the amount of fuel injected in the first fuel injection 1001. This suppresses the generation of HC and PN.

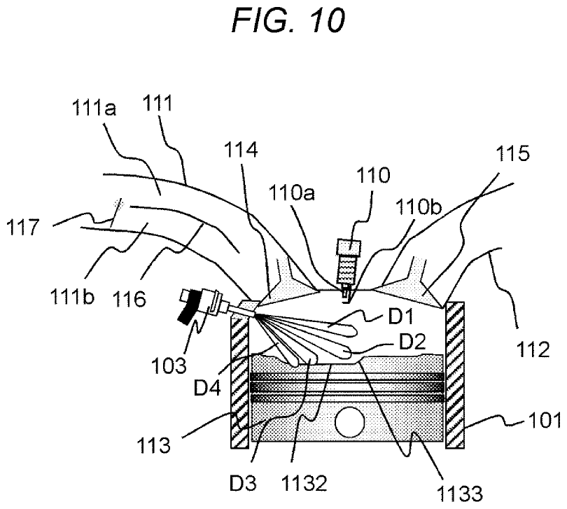

Fuel injection control of the injector 103 by the control unit 21 of the ECU 2 will be described with reference to FIGS. 8 to 10. FIG. 8 is a cross-sectional view taken along the line A-A in FIG. 5, and is a schematic view illustrating the state of the fuel injected from the injector 103 when the direction of the injector 103 is viewed from the cross section A-A. FIG. 9 is a view illustrating the changes over time of the pulse width of the fuel control signal 300 output from the control unit 21 according to the embodiment of the present invention, the drive current 400, and the displacement amount of the valve body 1033. FIG. 10 is a view illustrating the state of the fuel injected from the injector 103 in the compression stroke S2.

First, as shown in FIG. 8, the injector 103 according to the embodiment is a multi-hole type injector having a plurality of fuel injection holes 1031, and is provided so as to be able to emit, for example, sprays in six directions, namely, a spray Dl directed to the ignition plug 110, sprays D2 and D6 in directions near the intake valve 114, and sprays D3, D4, and D5 directed to the piston 113.

In the fuel injection in the compression stroke S2, the control unit 21 can form a fuel rich air-fuel mixture around the ignition plug 110 by putting the sprays D4 and Dl into the cavity 1132 of the piston 113. Further, the sprays D2 and D6 or the sprays D3 and D5 may be put in the cavity 1132 depending on the size of the cavity 1132 and the fuel injection timing. This can also form a fuel rich air-fuel mixture around the ignition plug 110.

Next, as shown in FIG. 9, the control unit 21 controls the injector 103 to perform injection (first fuel injection 1001) at least two times at a position where the displacement amount of the valve body 1033 is lower than the maximum height position Hmax in the intake stroke S1. Subsequently, the control unit 21 controls the injector 103 so as to perform the second fuel injection 1002 in which the displacement amount of the valve body 1033 is larger than that of the first fuel injection 1001. In this case, in the control unit 21 of the embodiment, periods in which the valve body 1033 is opened and fuel is injected in the first fuel injection 1001 are defined as injection periods p11, p12, and p13, and a period in which the valve body 1033 is opened and fuel is injected in the second fuel injection 1002 is defined as an injection period p14. In this case, the pulse width of the fuel control signal 300 (the energization time of the drive current 400) is set such that each of the injection periods p11, p12, and p13 is shorter than the injection period p14. In this case, the control unit 21 controls the injector 103 such that the total period (P11+P12+P13) of the injection periods P11, P12, and P13 in the first fuel injection 1001 performed in the intake stroke S1 becomes longer than the injection period P14 in the second fuel injection 1002 performed in the compression stroke S2 (P11+P12+P13>P14).

In the control unit 21, the flow rate of fuel per unit time in a period P15 from the timing t12 when the valve body 1033 for the first fuel injection 1001 starts opening the valve, that is, the timing when the fuel injection starts, to the timing t13 when the first fuel injection 1001 ends is set to be smaller than the fuel flow rate per unit time in the period p14 from the timing t14 when the valve body 1033 for the second fuel injection 1002 starts opening the valve, that is, the timing when fuel injection starts, to the timing t15 when the second fuel injection 1002 ends.

The control unit 21 controls the injector 103 such that the displacement amount of the valve body 1033 becomes smaller than the maximum height position Hmax, and performs the first fuel injection 1001 in the intake stroke S1 with the fuel pressure of the fuel injected from the injector 103 being low (the flow rate per unit time being small). This makes it possible to promote the mixing of air and fuel in the cylinder 1021 and form a homogeneous air-fuel mixture in the internal combustion engine 100, thereby suppressing NOx emissions. Further, in the first fuel injection 1001, since the displacement amount of the valve body 1033 is smaller than the maximum height position Hmax of the displacement of the valve body 1033, the pressure loss between the valve body 1033 and the seat portion 1033b becomes large. This shortens the reach (penetration) of the fuel spray injected from the fuel injection hole 1031. As a result, it is possible to prevent the spray of the fuel injected from the injector 103 from adhering to the bore wall surface and the crown surface 1131 of the piston 113 and to reduce the HC.

In order to perform the first fuel injection 1001 to inject fuel while the displacement amount of the valve body 1033 is smaller than the maximum height position Hmax, the control unit 21 performs control to make the pulse width of the fuel control signal 300 smaller than in the second fuel injection 1002 and reduce the drive current 400 to be supplied to the solenoid 1032. This makes it possible to perform control to reduce the magnetic attraction force acting on the valve body 1033 and make the displacement amount of the valve body 1033 smaller than the maximum height position Hmax.

FIG. 9 has exemplified the case in which the first fuel injection 1001 in the intake stroke S1 is performed three times. However, the first fuel injection 1001 may be performed two or more times (for example, four times or five times or more).

The control unit 21 controls the injector 103 such that the displacement amount of the valve body 1033 becomes equal to the maximum height position Hmax, and performs the second fuel injection 1002 in the compression stroke S2 with the fuel pressure of the fuel injected from the injector 103 being higher than that in the first fuel injection 1001 (the flow rate per unit time being large). This makes it possible to inject a small amount of fuel spray having a strong penetration force, that is, a long penetration from the injector 103. As a result, the air-fuel mixture can reliably reach the ignition plug 110, and PN and HC can be suppressed. Further, the control unit 21 controls the injector 103 to perform the second fuel injection 1002 in which the displacement amount of the valve body 1033 is larger than that in the first fuel injection 1001 by performing control to increase the pulse width of the fuel control signal 300 for the second fuel injection 1002 and increase the drive current 400 supplied to the solenoid 1032. As a result, in the injector 103, the magnetic attraction force acting on the valve body 1033 is increased, and the displacement amount of the valve body 1033 in the second fuel injection is made larger than the displacement amount of the valve body 1033 in the first fuel injection.

In the embodiment, the control unit 21 sets the injection timing t14 of the second fuel injection 1002 in one fuel cycle of the internal combustion engine 100 to a timing later than the injection timing t12 of the first fuel injection 1001, in particular, within the period of compression stroke S2. The control unit 21 controls the injector 103 to perform the second fuel injection 1002 during the compression stroke S2, so that the fuel is injected at the timing when the piston 113 moves toward TDC, and a large amount of injected fuel can be made to enter the cavity 1132 formed in the crown surface 1131 of the piston 113. As a result, the fuel that has entered the cavity 1132 is blown up toward the ignition plug 110, and a fuel rich air-fuel mixture can be formed around the ignition plug 110. Further, the shorter the distance between the injector 103 and the cavity 1132 of the piston 113, the easier the fuel injected from the injector 103 enters the cavity 1132. Accordingly, for example, the control unit 21 preferably controls the injector 103 to perform the second fuel injection 1002 after 70deg before the crank angle reaches TDC (at a slow timing in one fuel cycle). As shown in FIG. 10, the control unit controls the injector 103 to perform the second fuel injection 1002 after 70 deg before the crank angle reaches TDC (at a slow timing in one fuel cycle). This causes many of the fuel sprays D2 to D6 injected from the injector 103 to enter the cavity 1132 of the piston 113 located closer to the injector 103, so that the fuel spray entering the cavity 1132 comes into contact with an inclined surface 1133 of the cavity 1132 and is blown up toward the ignition plug 110, thereby forming a fuel rich air-fuel mixture around the ignition plug 110.

FIG. 9 has exemplified the case in which the second fuel injection 1002 performed in the compression stroke S2 according to the embodiment is performed once. However, the second fuel injection 1002 performed in the compression stroke S2 may be divisionally performed two or more times. Assume that the second fuel injection 1002 is divisionally performed in two steps. In this case, after an air-fuel mixture is formed in the cavity 1132 in the first injection, the speed of the spray D6 close to the cavity 1132 decreases in the second injection, and the speed of the spray Dl far from the cavity 1132, that is, the wall surface, does not decrease. This generates a vertical differential pressure in the cylinder 1021 and can enhance the effect of blowing up the air-fuel mixture formed in the cavity 1132 toward the ignition plug 110.

As described above, according to the first embodiment, (1) the control device 1 for controlling the injector 103 includes the control unit 21 that controls the injector 103 to perform the first fuel injection 1001 for injecting fuel at the first fuel pressure from the injector 103 in the intake stroke S1 in one combustion cycle of the internal combustion engine 100 and the second fuel injection 1002 for injecting fuel at the second fuel pressure higher than the first fuel pressure from the injector 103 after the first fuel injection 1001 in the same one combustion cycle in the intake stroke S1.

With this configuration, the control unit 21 performs spraying with a small fuel pressure in the first fuel injection 1001. This can improve the homogeneity of the air-fuel mixture in the combustion chamber, reduce the adhesion of the spray of the fuel injected from the injector 103 to the bore wall surface and the crown surface 1131 of the piston 113, and reduce the generation of PN and HC. Further, in the second fuel injection 1002 after the first fuel injection 1001, since the control unit 21 performs spraying with a large fuel pressure, the spray easily reaches the vicinity of the ignition plug 110 and can form a fuel rich air-fuel mixture near the ignition plug 110. Therefore, combustion stability can be improved.

(2) In addition, the control unit 21 is configured to control the injector 103 such that the second fuel injection 1002 is performed in the compression stroke S2 in the same one combustion cycle as the intake stroke S1 in which the first fuel injection 1001 is performed.

With this configuration, the spray produced by the second fuel injection 1002 is blown up near the ignition plug 110 by the piston 113 that has moved to TDC in the compression stroke S2 performed after the intake stroke S1, thereby forming a fuel rich air-fuel mixture near the ignition plug 110. Therefore, the ignition plug 110 is easily ignited and combustion stability is enhanced.

(3) The control unit 21 is configured to control the injector 103 such that the displacement amount of the mover 1036 of the injector 103 when performing the first fuel injection 1001 becomes smaller than the displacement amount of the mover 1036 of the injector 103 when performing the second fuel injection 1002.

With this configuration, the control unit 21 can make the fuel pressure of the fuel injected from the injector 103 in the first fuel injection 1001 become smaller than the fuel pressure of the fuel injected from the injector 103 when the valve body 1033 of the injector 103 is at the maximum height position Hmax. This can enhance the homogeneity of the air-fuel mixture in the cylinder 1021, reduce the adhesion of fuel to the bore wall surface and the piston 113, and reduce the generation of PN and HC.

(4) As described above, the control unit 21 is configured to control the injector 103 to make the penetration (the reach of spray) of the fuel sprayed in the second fuel injection 1002 become longer than the penetration (the reach of spray) of the fuel sprayed in the first fuel injection 1001.

With this configuration, the control unit 21 controls the injector 103 to reduce the penetration of the fuel injected in the first fuel injection 1001 in the intake stroke S1, and hence can reduce the spray of the fuel which is injected from the injector 103 and adheres to the bore wall surface and the crown surface 1131 of the piston 113 and reduce PN and HC. Further, the control unit 21 controls injection such that the penetration of the fuel injected in the second fuel injection 1002 in the compression stroke S2 becomes long. As a result, the fuel arriving at the crown surface 1131 of the piston 113 is blown up in the direction of the ignition plug 110, and the air-fuel mixture around the ignition plug 110 becomes a fuel rich state due to the blown-up fuel, thereby improving the combustion stability. In addition, the adhesion of fuel to the bore wall surface and the like can be reduced, and PN and HC can be suppressed.

(5) The control unit 21 is configured to control the injector 103 to make the injection time (total time (p11+p12+p13) of the injection times (p11, p12, and p13)) of the fuel injected from the injector 103 in the first fuel injection 1001 become longer than the injection time p14 of the fuel injected from the injector 103 in the second fuel injection 1002.

With this configuration, the control unit 21 controls the injector 103 such that spray having a low fuel pressure is performed for a longer time in the first fuel injection 1001 in the intake stroke S1 so as to perform spray having a short penetration for a long time. This can improve the homogeneity of the air-fuel mixture in the cylinder 1021. The control unit 21 can implement spray having a long penetration for a short time by performing spray having a high fuel pressure for a long time in the second fuel injection 1002 in the compression stroke S2, and make the spray reach the cavity 1132 of the piston 113 to form a fuel rich air-fuel mixture near the ignition plug 110.

(6) Further, the control unit 21 is configured to control the injector so that the first fuel injection 1001 is performed a plurality of times in the intake stroke S1 in one fuel cycle of the internal combustion engine 100.

With this configuration, the control unit 21 can further improve the homogeneity of an air-fuel mixture in the cylinder 1021 in the intake stroke S1 by performing spraying for a short time a plurality of times in the intake stroke S1.

(7) The control unit 21 is configured to control the injector 103 to inject fuel at a position where the displacement amount of the valve body of the injector 103 in the first fuel injection 1001 does not reach the maximum (maximum height Hmax).

With this configuration, the control unit 21 sprays fuel while the displacement amount of the valve body 1036 of the injector 103 in the first fuel injection 1001 has not reached the maximum height position Hmax. This makes it possible to perform spraying with a short penetration in the first fuel injection 1001.

(8) The control unit 21 is configured to control the injector 103 to inject fuel at a position where the displacement amount of the valve body 1036 of the injector 103 in the second fuel injection 1002 reaches the maximum (maximum height Hmax).

With this configuration, the control unit 21 sprays fuel while the displacement amount of the valve body 1036 of the injector 103 in the second fuel injection 1002 has reached the maximum height position Hmax. This makes it possible to perform spraying with a long penetration in the second fuel injection 1002.

### Second Embodiment

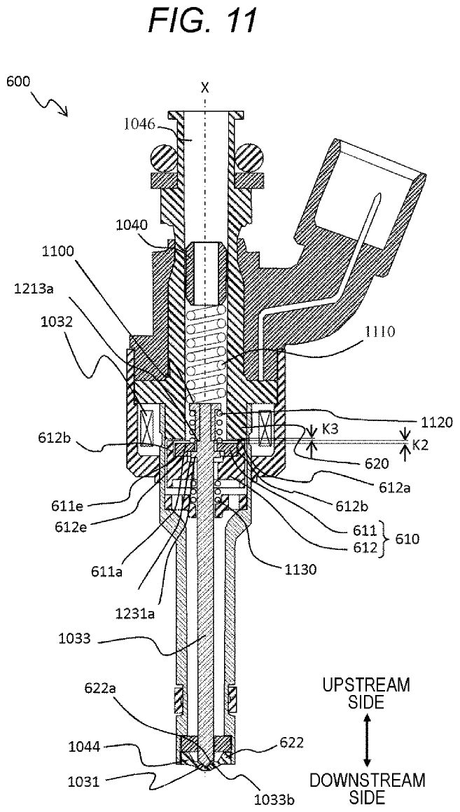

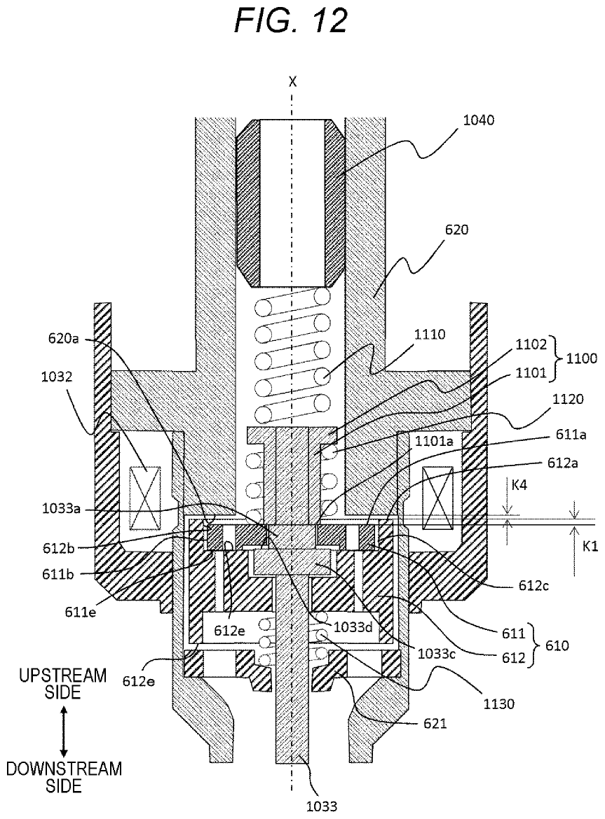

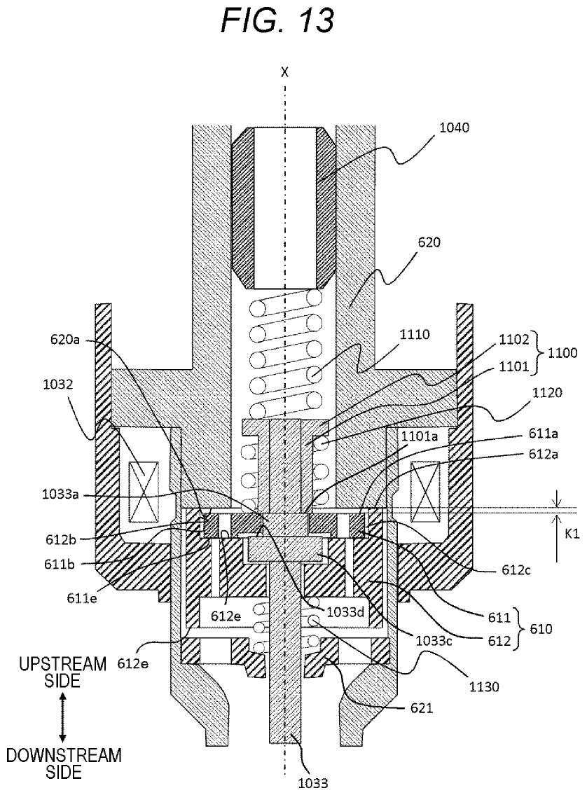

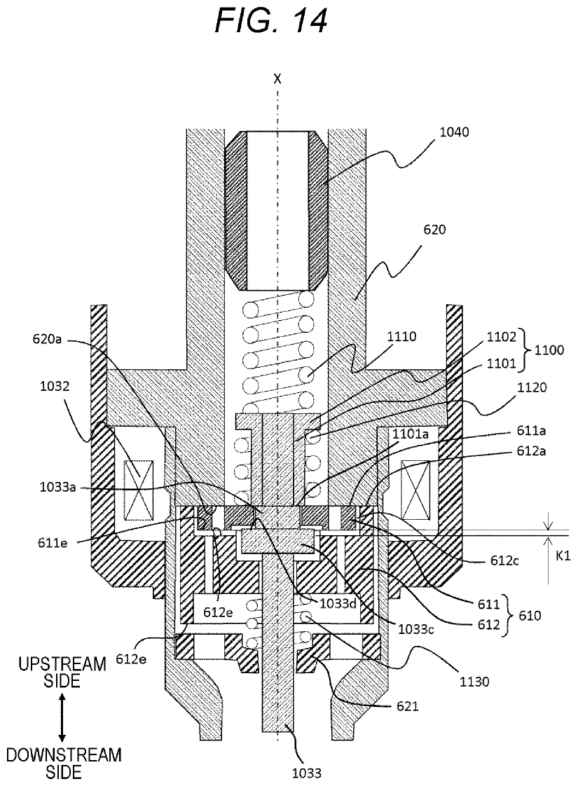

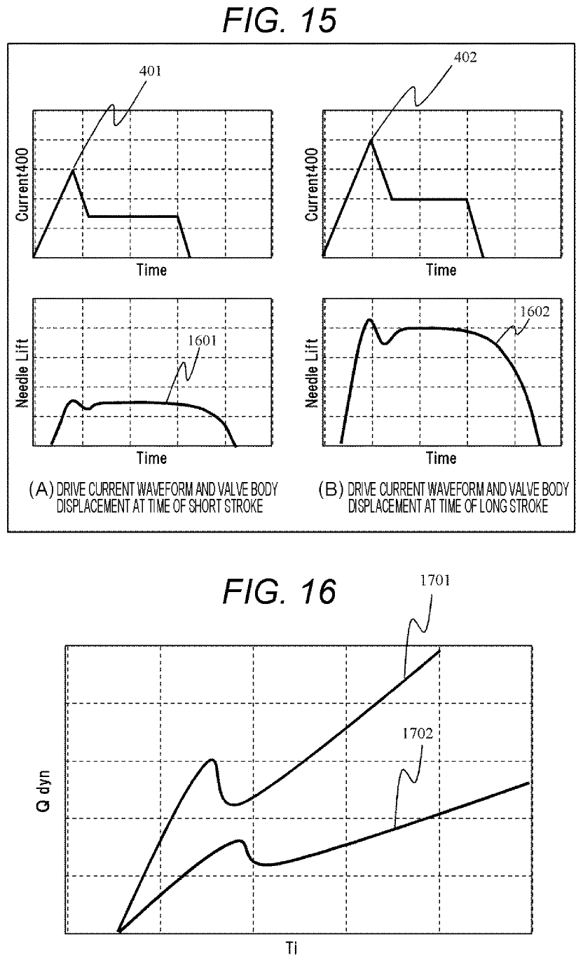

An injector 600 according to the second embodiment of the present invention will be described with reference to FIGS. 11 to 16. FIG. 11 is a cross-sectional view illustrating the structure of the injector 600 according to the second embodiment. FIG. 12 is an enlarged view of the vicinity of a mover mechanism 610, showing a state in which the mover mechanism 610 is pressed by a first spring 1110 in the direction of a fuel injection hole 1031. FIG. 13 is an enlarged view of the vicinity of the mover mechanism 610, showing a short stroke state in which a second mover 611 of the mover mechanism 610 is attracted by a solenoid 1032. FIG. 14 is an enlarged view of the vicinity of the mover mechanism 610, showing a long stroke state in which a first mover 611 and a second mover 612 are attracted by the solenoid 1032. FIG. 15 is a view illustrating an example of a drive current 400 supplied to the solenoid 1032 of the injector 600. FIG. 16 is a view illustrating an example of the relation between a fuel control signal 300 and a fuel injection quantity. The same components as those in the first embodiment described above are denoted by the same reference numerals, and detailed description thereof will be omitted.

The injector 600 according to the second embodiment differs from the injector 103 according to the embodiment described above in that the mover that drives a valve body 1033 is divided into two parts (the first mover 611 and the second mover 612, which are collectively referred to as the mover mechanism 610), and the displacement amount of the valve body 1033 in the axis X direction can be adjusted stepwise (short stroke and long stroke). An engaging member 1100 (sleeve portion) is attached to the upstream distal end portion of the valve body 1033. The engaging member 1100 has a cylindrical portion 1101 provided on the outer diameter side of the small diameter portion of the valve body 1033, and a projection 1102 protruding outward in the radial direction at the upper end (see FIG. 12).

The valve body 1033 is biased toward the fuel injection hole 1031 (downstream side) in the axis X direction by the first spring 1110 via the projection 1102 of the engaging member 1100. Since the biasing force of the first spring 1110 toward the downstream side is set to be larger than the biasing force of a third spring 1130 toward the upstream side, when the solenoid 1032 is in the non-energized state, the valve body 1033 is biased toward the fuel injection hole 1031 to set the injector 600 in the valve closed state. The lower surface of the projection 1102 of the engaging member 1100 holds a second spring 1120 that biases the mover mechanism 610 toward the fuel injection hole 1031 in the axis X direction.

The mover mechanism 610 is configured to have the first mover 611 and the second mover 612 provided separately from the first mover 611, and is provided independently of the valve body 1033.

The first mover 611 of the mover mechanism 610 has a first opposing surface 611a facing a magnetic core 620, and the first opposing surface 611a is attracted by the magnetic attraction force of the magnetic core 620. The second mover 612 has a second opposing surface 612a facing the magnetic core 620, and the second opposing surface 612a is configured to be attracted by the magnetic attraction force of the magnetic core 620. With the configuration of this injector 600, the first mover 611 and the second mover 612 are attracted toward the magnetic core 620 by the magnetic attraction force. This pushes up the valve body 1033 in the valve opening direction.

The injector 600 is configured such that when the second mover 612 moves in the direction of the magnetic core 620 due to the magnetic attraction force generated between the magnetic core 620 and the second mover 612, the valve body 1033 moves to the upstream side (in the direction in which the valve body 1033 moves away from the fuel injection hole 1031) along the axis X accompanying the movement of the second mover 612 in the direction of the magnetic core 620.

On the other hand, the second opposing surface 612a of the second mover 612 is arranged radially outside the first opposing surface 611a of the first mover 611.

An outer peripheral surface 611b of the first mover 611 is arranged to face an inner peripheral surface 612b of the second mover 612 with a gap in a direction (horizontal direction) orthogonal to the axis X direction.

A downstream end face 611e of the first mover 611 is arranged to face an upstream end face 612e of the second mover 612 in the axis X direction (the vertical direction in FIG. 12). Note that, as shown in FIG. 12, in the valve closed state in which neither the first mover 611 nor the second mover 612 is attracted to the magnetic core 620, the downstream end face 611e of the first mover 611 and the upstream end face 612e of the second mover 612 come into contact with each other.

As shown in FIG. 12, the second mover 612 has a recess 612c that is recessed downstream from the second opposing surface 612a and formed on the inner diameter side, and all of the first mover 611 is accommodated inside this recess 612c. More specifically, in the valve closed state in which neither the first mover 611 nor the second mover 612 is attracted to the magnetic core 620, the first opposing surface 611a of the first mover 611 is located closer to the downstream side along the axis X than the second opposing surface 612a of the second mover 612. In this state, a predetermined gap K1 is provided between the first opposing surface 611a and the second opposing surface 612a.

The valve body 1033 has a valve body engaging portion 1033a that engages with the first mover 611. Although the embodiment will exemplify the case in which the valve body 1033 and the engaging member 1100 are separately configured, the valve body 1033 and the engaging member 1100 may be integrally configured. When the first mover 611 moves upstream along the axis X, the first opposing surface 611a of the first mover 611 and a downstream end face 1101a of the cylindrical portion 1101 of the engaging member 1100 are engaged, and the engaging member 1100 is pushed up to the upstream side. The valve body 1033 then moves to the upstream side (in the valve opening direction).

In this case, the first mover 611 has the downstream end face 611e (first engaging portion) that engages with the second mover 612. When the second mover 612 moves upstream along the axis X, the upstream end face 612e (second engaging portion) of the second mover 612 and the downstream end face 611e (first engaging portion) of the first mover 611 engage with each other to move the first mover 611 to the upstream side. This causes the first opposing surface 611a of the first mover 611 to engage with the downstream end face 1101a of the cylindrical portion 1101 of the engaging member 1100 to push up the engaging member 1100 to the upstream side. This moves the valve body 1033 engaging with the engaging member 1100 to the upstream side (in valve opening direction).

With the configuration described above, the valve body 1033 is driven to the upstream side via the first mover 611 by the attraction of the second mover 612 by the magnetic attraction force of the magnetic core 620.

Further, as shown in FIG. 12, the second spring 1120 is provided between the first mover 611 and the projection 1102 of the engaging member 1100. The second spring 1120 exerts a biasing force in a direction in which the first mover 611 and the engaging member 1100 are separated from each other. A spring holding member 621 is provided on the downstream side of the mover mechanism 610, and the third spring 1130 is provided between the spring holding member 621 and the second mover 612. The third spring 1130 exerts a biasing force in a direction in which the second mover 612 and the spring holding member 621 are separated from each other.

In this case, when the absolute value of a biasing force Fz of the third spring 1130 is compared with the absolute value of a biasing force Fm of the second spring 1120, the absolute value of the biasing force of the second spring 1120 is set to be larger. Accordingly, when the drive current 400 is supplied to the solenoid 1032, a magnetic flux is generated in the gap between the magnetic core 620 and the second mover 612 having an attraction surface (the second opposing surface 612a) formed on the outer diameter side, and so in the gap between the magnetic core 620 and the first mover 611 having an attraction surface (the first opposing surface 611a) formed on the inner diameter side. This generates a magnetic attraction force for attracting the first mover 611 and the second mover 612.

As shown in FIGS. 11 and 12, while the solenoid 1032 is not energized, the first spring 1110 biases the engaging member 1100 to the downstream side along the axis X to bring a seat portion 1033b of the valve body 1033 into contact with a seat surface 622a of a seat member 622, thereby closing the valve. In this case, the second spring 1120 biases the first mover 611 to the downstream side along the axis X to bias an upstream end face 1033d (contact surface) of a projection 1033c (stepped portion) provided on the valve body 1033 to the downstream side. The valve body 1033 is stationary in this state.

The third spring 1130 biases the second mover 612 to the upstream side (valve opening direction) along the axis X to engage the upstream end face 612e of the second mover 612 with the downstream end face 611e (first engaging portion) of the first mover 611, thereby holding the second mover 612 in a stationary state. In this stationary state, a gap K2 (see FIG. 11) is provided between the first opposing surface 611a of the first mover 611 and a downstream end face 1101a of the cylindrical portion 1101 of the engaging member 1100.

When the drive current 400 is supplied to the solenoid 1032 in the state shown in FIG. 11, a magnetic attraction forces are respectively generated between the magnetic core 620 and the first mover 611 and between the magnetic core 620 and the second mover 612.

As indicated by inequality (1) below, when the sum of a magnetic attraction force Fi acting between the first mover 611 and the magnetic core 620 and a magnetic attraction force Fo acting between the second mover 612 and the magnetic core 620 becomes larger than the difference between a biasing force Fm of the second spring 1120 and a biasing force Fz of the third spring 1130, the first mover 611 and the second mover 612 are attracted to the magnetic core 620 side, and the valve body 1033 starts to move.

Fi+Fo>Fm−Fz (1)

When the first mover 611 is displaced upstream along an axis X by the preset gap K2 between the engaging member 1100 and the first mover 611 on the inner diameter side, a gap K3 (see FIG. 11) set between a downstream end face 620a of the magnetic core 620 and the second opposing surface 612a of the second mover 612 is reduced to a gap K4 (see FIG. 12). In the embodiment, the relationship of K3−K4=k1 is established. The gap K4 can be referred to as the clearance between the second opposing surface 612a of the second mover 612 and the downstream end face 620a of the magnetic core 620 while the first opposing surface 611a of the first mover 611 is in contact with the downstream end face 1101a of the cylindrical portion 1101 of the engaging member 1100. In the state shown in FIG. 12, the first opposing surface 611a of the first mover 611 is in contact with the downstream end face 1101a (contact surface) of the cylindrical portion 1101 of the engaging member 1100. The gap K2 between the first opposing surface 611a of the first mover 611 and the downstream end face 1101a of the cylindrical portion 1101 of the engaging member 1100 may be referred to as a preliminary stroke. Due to this gap K2, in the injector 600, the kinetic energy stored in the first mover 611 and the second mover 612 is used for the valve opening operation of the valve body 1033. The responsiveness of the valve opening operation can be improved by the amount of kinetic energy used, and the valve can be opened even under high fuel pressure. In order to secure the gap K2 (preliminary stroke), it is necessary to set the gap K3>the gap K2 when the injector 600 shown in FIG. 11 is in the valve closed state.

The state shown in FIG. 13 is set when the drive current 400 is continuously supplied to the solenoid 1032, and the second mover 612 is further displaced upstream along the axis X by the gap K4 provided in advance between the second opposing surface 612a of the second mover 612 and the downstream end face 620a of the magnetic core 620. In this state, the movement of the second mover 612 to the upstream side along the axis X is restricted by the downstream end face 620a of the magnetic core 620.

The relationship between the drive current 400 to the solenoid 1032 and the displacement amount of the valve body 1033 will be described below. FIG. 15(A) shows the relationship between the drive current 400 and the displacement amount of the valve body 1033 during a short stroke. FIG. 15(B) shows the relationship between the drive current 400 and the displacement amount of the valve body 1033 during a long stroke. The embodiment will exemplify a case in which a peak current 401 of the drive current 400 supplied to the solenoid 1032 is set smaller than a set value, as shown in FIG. 15.

This case satisfies the force relation defined by inequality (2), that is, a condition that the sum of the magnetic attraction force Fi acting on the first mover 611 and the magnetic attraction force Fo acting on the second mover 612 is larger than the sum of the differential pressure Fp due to the fuel (fluid) acting on the valve body 1033 and the biasing force Fs of the first spring 1110.

In addition, control is performed to satisfy the force relation defined by inequality (3), that is, a condition that the magnetic attraction force Fi acting on the first mover 611 is smaller than the sum of the differential pressure Fp due to fuel (fluid) acting on the valve body 1033 and the biasing force Fs of the first spring 1110.

Fs+Fp<Fi+Fo (2)

Fs+Fp>Fi (3)

Therefore, in the case of the drive current 400 shown in FIG. 15(A), when the control device 1 controls the injector 600 so as to satisfy inequalities (2) and (3) described above, the second opposing surface 612a of the second mover 612 comes into contact with the downstream end face 620a of the magnetic core 620 to eliminate the gap K4 between the second opposing surface 612a and the downstream end face 620a and leave only a gap K1 between the first opposing surface 611a of the first mover 611 and the downstream end face 620a of the magnetic core 620, as shown in FIG. 13. That is, as indicated by inequality (2) described above, the valve body 1033 is displaced upstream along the axis X upon receiving the magnetic attraction force Fo acting on the second mover 612. However, as indicated by inequality (3) described above, the magnetic attraction force Fi acting on the first mover 611 alone cannot displace the valve body 1033. As a result, the injector 600 is set in a short stroke state in which the valve body 1033 (second mover 612) is displaced upstream by an amount corresponding to the gap K4.

While the displacement amount of the valve body 1033 shown in FIG. 13 corresponds to a short stroke state, when the drive current 400 supplied to the solenoid 1032 is cut off or lowered to a current (intermediate current) lower than the peak current 401, the magnetic fluxes generated between the magnetic core 620 and the first mover 611 and between the magnetic core 620 and the second mover 612 are eliminated or reduced. Accordingly, when the sum (Fi+Fo) of the magnetic attraction force Fi acting on the first mover 611 and the magnetic attraction force Fo acting on the second mover 612 becomes smaller than the sum (Fs+Fp) of the biasing force Fs of the first spring 1110 and the differential pressure Fp of fuel (fluid) acting on the valve body 1033 (Fs+Fp>Fi+Fo), the first mover 611 and the second mover 612 start being displaced downstream along the axis X. The valve body 1033 then starts a valve closing operation. Thereafter, the seat portion 1033b of the valve body 1033 comes into contact with the seat surface 622a of the seat member 622 to close the valve.

Therefore, in the case of the waveform of the drive current 400 like that shown in FIG. 15(A), the valve body 1033 is displaced by an amount corresponding to a valve body displacement 1601 provided between the second opposing surface 612a of the second mover 612 and the downstream end face 620a of the magnetic core 620. The valve body displacement 1601 corresponds to the gap K4 shown in FIG. 12.

The second mover 612 is restricted from moving toward the upstream side in the axis X direction by collision with the downstream end face 620a of the magnetic core 620 or a member different from the magnetic core 620. This stabilizes the displacement amount of the valve body 1033, and hence allows the injector 600 to implement stable fuel injection.

Described below is a case in which a peak current 402 of the drive current 400 supplied to the solenoid 1032 is made larger than a preset set value, as shown in FIG. 15(B). That is, when the valve body 1033 is driven in the long stroke state, the peak current 402 in the long stroke state is made larger than the peak current 401 in the short stroke state. In this case, as indicated by inequality (4) given below, control is performed to make the magnetic attraction force Fi acting on the first mover 611 become larger than the sum of the biasing force Fs of the first spring 1110 and the differential pressure Fp of fluid (fuel) acting on the valve body 1033.

Fs+Fp<Fi (4)

Accordingly, as shown in FIG. 14, the first mover 611 is displaced upstream along the axis X by an amount corresponding to the gap K1 provided between the downstream end face 620a of the magnetic core 620 and the first opposing surface 611a of the first mover 611. As a result, the first mover 611 moves the valve body 1033 further upstream from the state shown in FIG. 13 by an amount corresponding to the gap K1, and hence the valve body 1033 moves upstream by a displacement amount corresponding to the sum of the gaps K4 and K1 as compared to when not energized. In the injector 600, a state in which the valve body 1033 is displaced upstream by the displacement amount (K4+K1) is called a long stroke state. Note that the displacement of the first mover 611 is restricted by collision with the magnetic core 620, so the stabilizing the behavior of the valve body 1033 after the collision between the first mover 611 and the magnetic core 620 allows the injector 600 to implement stable fuel injection.

A control unit 21 shuts off the drive current 400 supplied to the solenoid 1032 in the state in which the displacement amount of the valve body 1033 becomes equivalent to a long stroke (the state shown in FIG. 14), or reduces the drive current 400 to a current smaller than the peak current 402 (intermediate current). This eliminates or reduces the magnetic flux generated between the first mover 611 and the magnetic core 620. When the magnetic attraction force Fi between them becomes smaller than the sum of the biasing force Fs of the first spring 1110 and the pressure difference Fp of the fuel (fluid) acting on the valve body 1033 (Ps+Fp>Fi), the first mover 611 is displaced downstream along the axis X.

The magnetic flux generated from the magnetic core 620 starts to disappear from the first mover 611, and the first mover 611 starts, at the same time, a valve closing operation earlier than the second mover 612 due to the pressure difference Fp of the fuel acting on the valve body 1033 and the biasing force Fs of the first spring 1110. As a result, the first mover 611 is displaced downstream by the gap K1 between the downstream end face 611e of the first mover 611 and the upstream end face 612e of the second mover 612, and collides with the upstream end face 612e of the second mover 612. As the second mover 612 collides with the first mover 611, the second mover 612 is displaced downstream together with the first mover 611.

The valve body 1033 starts a valve closing operation accompanying the displacement of the first mover 611 and the second mover 612 described above, and the seat portion 1033b of the valve body 1033 then comes into contact with the seat member 622 to close the valve. As a result, as shown in FIG. 15(B), the valve body 1033 has a long stroke, and its displacement amount is as indicated by reference numeral 1602. The displacement amount 1602 corresponds to the total value of the gap K4 and the gap K1.

In the embodiment, varying the drive current 400 supplied to the solenoid 1032 of the injector 600 can switch the displacement of the valve body 1033 between the short stroke shown in FIG. 15(A) and the long stroke shown in FIG. 15(B). In the valve closed state of the injector 600, the first clearance (gap K3+gap K1 or gap K4+gap K1) between the first opposing surface 611a of the first mover 611 and the magnetic core 620 is larger than the second clearance (gap K3 or gap K4) between the second opposing surface 612a of the second mover 612 and the magnetic core 620.

In this case, the gap K2 can be defined as the clearance between the first opposing surface 611a of the first mover 611 in the valve closed state and the downstream end face 1101a of the cylindrical portion 1101 of the engaging member 1100 (see FIG. 11). The gap K4 can be defined as the clearance between the second opposing surface 612a of the second mover 612 and the downstream end face 620a of the magnetic core 620 while the first opposing surface 611a of the first mover 611 is in contact with the downstream end face 1101a of the cylindrical portion 1101 of the engaging member 1100 (see FIG. 12). The gap K1 can be defined as the clearance between the first opposing surface 611a of the first mover 611 and the downstream end face 620a of the magnetic core 620 while the second opposing surface 612a of the second mover 612 is in contact with the downstream end face 620a of the magnetic core 620 (see FIG. 13).

In the injector 600 described above, when the displacement of the valve body 1033 is switched between the short stroke shown in FIG. 15(A) and the long stroke shown in FIG. 15(B) by the drive current 400, the gaps K1 and K4 are preferably set to satisfy gap K1>gap K4. Since stroke adjustment is performed when the injector 600 is assembled, the gap K4 can be set with high accuracy. In the embodiment, the gap K4 and the gap K2 that determines a preliminary stroke amount are set to be substantially the same or satisfy gap K1>gap K2.

In this way, the mover mechanism 610 of the injector 600 is divided into the first mover 611 and the second mover 612, and the control unit 21 changes the drive current 400 supplied to the solenoid 1032 to change the displacement amount of the valve body 1033 between the short stroke and the long stroke.

FIG. 16 shows the injection amount characteristics (relationship between injection command periods and injection amounts) of the injector 600 in the respective strokes. As described with reference to FIG. 4, in the injector 600, changing the waveform of the drive current 400 according to the required fuel injection quantity (fuel pressure) can obtain a long stroke injection amount characteristic 1701 and a short stroke injection amount characteristic 1702. Therefore, in the injector 600, when the required fuel pressure of fuel is high (the injection amount is large), the injection amount characteristic 1701 in the long stroke is applied. In contrast to this, when the required fuel pressure of fuel is low (the injection amount is small), applying the injection amount characteristic 1702 in the short stroke can stably supply fuel at the optimum fuel pressure required for combustion in the internal combustion engine 100.

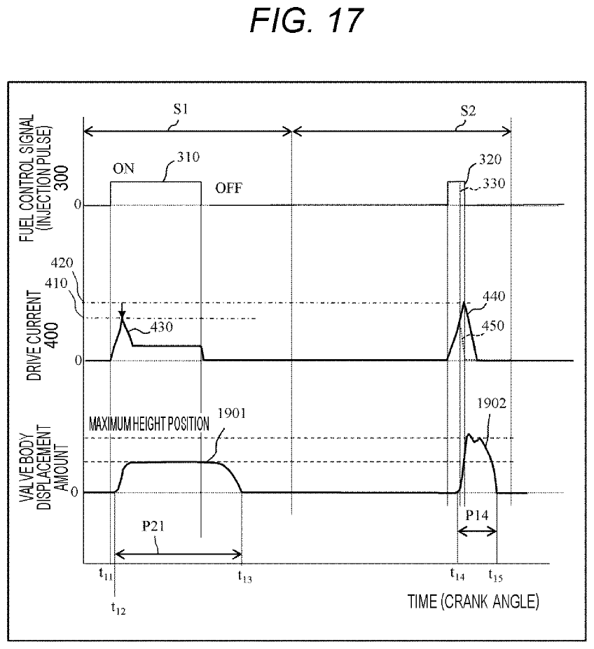

The control method of the injector 600 according to the second embodiment will be described with reference to FIGS. 15 and 17. FIG. 17 is a view showing the relationship over time between the fuel control signal 300, the drive current 400, and the displacement amount of the valve body 1033 according to the second embodiment of the present invention. The same reference numerals in FIG. 17 denote the same parts as in FIG. 9.

The control method of the injector 600 differs from the control method of the injector 103 according to the first embodiment in that the injector 600 is controlled to hold the valve body 1033 in a short stroke state in order to inject fuel from the injector 600 at a low fuel pressure for a predetermined period in the intake stroke S1 of one combustion cycle. As described above, the control unit 21 shifts the peak current supplied to the solenoid 1032 of the injector 600 from the peak current 420 (the drive current for displacing the valve body 1033 with a long stroke) to the peak current 410 (the drive current for displacing the valve body 1033 with a short stroke). This makes it possible to hold the valve body 1033 in the short stroke state while holding the second mover 612 in contact with the magnetic core 620. Holding the valve body 1033 in a short stroke state can perform the first fuel injection 1901 with a low fuel pressure for a long time like the injection period P21 and further improve the homogeneity of an air-fuel mixture in the cylinder by promoting the mixture of air and fuel. This makes it possible to reduce NOx in an exhaust gas and enhance combustion stability because of high homogeneity.

In a second fuel injection 1902 in the compression stroke S2 after a first fuel injection 1901 in the same one combustion cycle, the valve body 1033 can be set in a long stroke state by increasing the peak current of the drive current 400 to a current larger than that in first fuel injection 1901 up to a peak current 420 and bringing the first mover 611 into contact with the magnetic core 620. Due to the large displacement amount of the valve body 1033, fuel with a long penetration (penetration force) is injected from the injector 600. Accordingly, even with a small injection amount in a short time, an air-fuel mixture can be made to reach an ignition plug 110 and combustion stability can be improved.

Further, since the first fuel injection 1901 is performed in the intake stroke S1 in which the air drift in a cylinder 1021 is strong, the homogeneity of the air-fuel mixture can be improved. On the other hand, in order to put the fuel injected from the injector 103 into a cavity 1132 of a piston 113 and blow up the fuel in the direction of the ignition plug 110, it is effective to perform the second fuel injection 1902 in the compression stroke S2 in which the piston 113 approaches TDC from BDC. It is particularly preferable to perform the second fuel injection 1902 at a timing after 70 deg (a slow timing in one fuel cycle) before the crank angle in the compression stroke S2 reaches TDC. With this operation, much of the fuel sprays D2 to D6 injected from the injector 600 enters the cavity 1132 of the piston 113 located closer to the injector 600. As a result, the fuel spray entering this cavity 1132 hits the inclined surface 1133 of the cavity 1132 and blown up in the direction of the ignition plug 110, thereby forming a fuel rich air- fuel mixture around the ignition plug 110.

In the second embodiment, the control unit 21 sets the waveform of a drive current in advance in the memory (not shown) provided in a drive circuit 3, and reads out the waveform of the drive current corresponding to the injection from the memory (not shown).). The embodiment is configured to store in advance the waveform of a drive current 430 for performing the first fuel injection 1901 and the waveform of a drive current 440 for performing the second fuel injection 1902 in the memory (not shown) of the drive circuit 3 and to read out the waveform of the drive current 430 or 440 from the memory in accordance with required injection and change the waveform. Alternatively, the memory (not shown) of the drive circuit 3 may store in advance the waveform of the drive current 430 corresponding to the first fuel injection 1901 and the waveform of the drive current 440 corresponding to the second fuel injection 1902 as preset values. The waveform of the drive current stored in the memory (not shown) may be read out in accordance with a command value from the control unit 21. As shown in FIG. 17, for example, the control unit 21 outputs, to a drive circuit 400, a command value to switch an injection pulse 320 having a large pulse width (the solid line in FIG. 17) and an injection pulse 330 having a small pulse width (the dotted line in FIG. 17) so as to cause the drive circuit 400 to read out drive currents 440 and 450 corresponding to the command value from the memory and outputs them to the injector 600.

In the embodiment, when the control unit 21 outputs a command value for the injection pulse 330 having a small pulse width to the drive circuit 400, the drive circuit 400 reads out the current waveform 450 close to the peak current value of a short stroke (the dotted line in FIG. 17) from the memory. When the control unit 21 outputs a command value for the injection pulse 330 having a large pulse width to the drive circuit 400, the drive circuit 400 reads out the current waveform 440 close to the peak current value of a long stroke from the memory. Compared with the case in which a current waveform is generated in accordance with a required fuel injection quantity, this makes it possible to quickly change the current waveform by simply reading it from the memory.

As described above, assume that the set values of the first fuel injection 1901 and the second fuel injection 1902 are stored in the memory (not shown) in advance, and the set value of a drive current is changed in accordance with a command value from the control unit 21. In this case, the time for changing control constants such as a peak current and a holding current can be shortened, so that the set value can be changed quickly when the current waveform is switched multiple times in one combustion cycle, and the robustness of current control is enhanced. FIG. 17 shows the case in which a current waveform during one combustion cycle is changed in two steps (the short stroke current waveform 450 and the long stroke current waveform 440). However, the current waveform may be changed in two or more steps.

The above embodiments have exemplified the configurations in which the injectors 103 and 600 are attached to the sides in the cylinders 1021. However, the embodiment is also effective for a so-called direction configuration in which the injector 103 or 600 is attached to the center of the head in the cylinders 1021. In the direct system, the penetration force of the second fuel injection 1902 may not always be necessary because the distance between the injector and the ignition plug is reduced. In this case, in the second fuel injection 1902, fuel may be injected in a short stroke state as in the first fuel injection 1901.

As described above, in the second embodiment, (9) the control unit 21 is configured to control the injector 103 so as to hold the second mover 612 at a position where the displacement amount of the second mover 612 of the injector 103 in the first fuel injection 1001 is maximum.

With this configuration, in the first fuel injection 1001, the valve body 1033 of the injector 600 is held while being displaced upstream along the axis X by the maximum displacement amount (first variable amount) of the second mover 612. This can stabilize the fuel sprayed from the injector 600 in a low fuel pressure state.

(10) The control unit 21 is configured to change the magnitude of the peak value of the drive current 400 that controls the injector 600 at least once in the same combustion cycle in the internal combustion engine 100.

With this configuration, the control unit 21 can supply the drive currents 400 having different peak currents at least once in one combustion cycle (for example, the drive current 440 and the drive current 450 in FIG. 17) to the injector 600, thereby easily making fuel sprayed in the first fuel injection 1001 and the second fuel injection 1002 have different fuel pressures.

Although an example of each embodiment of the present invention has been described above, the present invention may be a combination of all the above embodiments or a combination of any two or more embodiments.

Further, the present invention is not limited to the one including all the configurations of the above embodiments, and a part of the configuration of the above embodiment may be replaced with the configuration of another embodiment. The configuration of the above embodiment may be replaced with the configuration of another embodiment.

Moreover, a part of the configuration of each embodiment described above may be added, deleted, and replaced with respect to the configurations of other embodiments.

### REFERENCE SIGNS LIST

1 control device
2 ECU
3 drive circuit
4 fuel injection system
5 various types of sensors
100 internal combustion engine
101 cylinder block
102 cylinder
1021 first cylinder
1022 second cylinder
1023 third cylinder
1024 fourth cylinder
103-106 injector
107 fuel pump
108 rail pipe
109 pressure sensor
110 ignition plug
111 intake port
112 exhaust port
113 piston
114 intake valve
115 exhaust valve
116 partition
117 valve
120 air cleaner
121 supercharger
122 supercharging chamber
123 intercooler
124 throttle valve
125 shaft
126 crankshaft
127 catalyst
300 fuel control signal
400 drive current
500 drive voltage
600 injector
610 mover mechanism
611 first mover
612 second mover
620 magnetic core
1001 first fuel injection
1002 second fuel injection
1031 fuel injection hole
1032 solenoid
1033 valve body
1033a valve body engaging part
1033b seat portion
1033c projection
1033d upstream end face
1034 spring
1035 valve seat
1036 mover
1036a end face
1037 spring
1038 nozzle holder
1038a end face
1039 fixed core
1041 housing
1042 magnetic diaphragm
1044 rod guide
1045 orifice
1046 the first fuel passage
1047 lower fuel passage
1100 engaging member
1101 cylindrical part
1101a other stream end face
1102 projection
1110 first spring
1120 second spring
1130 third spring
1131 crown surface
1132 cavity
1133 inclined surface
D1-D6 spray
S1 intake stroke
S2 compression stroke

1. An injector control device for controlling an injector, the control device comprising a control unit that controls the injector to perform a first fuel injection for injecting fuel at a first fuel pressure from the injector in an intake stroke in one combustion cycle of an internal combustion engine and a second fuel injection for injecting fuel at a second fuel pressure higher than the first fuel pressure from the injector after the first fuel injection in the same one combustion cycle in the intake stroke.

2. The injector control device according to claim 1, wherein the control unit controls the injector such that the second fuel injection is performed in the compression stroke in the same one combustion cycle as the intake stroke in which the first fuel injection is performed.

3. The injector control device according to claim 1, wherein the control unit controls the injector such that a displacement amount of a mover of the injector when performing the first fuel injection becomes smaller than a displacement amount of the mover of the injector when performing the second fuel injection.

4. The injector control device according to claim 1, wherein the control unit controls the injector such that a penetration of fuel injected in the second fuel injection is longer than a penetration of fuel injected in the first fuel injection.

5. The injector control device according to claim 1, wherein the control unit controls the injector such that the mover is held at a position where a displacement amount of the a mover of the injector in the first fuel injection is maximum.

6. The injector control device according to claim 1, wherein the control unit controls the injector such that an injection time of fuel injected from the injector in the first fuel injection is longer than an injection time of fuel injected from the injector in the second fuel injection.

7. The injector control device according to claim 1, wherein the control unit controls the injector such that the first fuel injection is performed a plurality of times in an intake stroke in the one fuel cycle in the internal combustion engine.

8. The injector control device according to claim 1, wherein the control unit controls the injector such that fuel is injected at a position where a displacement amount of a valve body of the injector in the first fuel injection is not maximum.

9. The injector control device according to claim 1, wherein the control unit controls the injector such that fuel is injected at a position where a displacement amount of a valve body of the injector in the second fuel injection is maximum.

10. The injector control device according to claim 1, wherein the control unit changes a magnitude of a peak value of a current that controls the injector at least once in the same combustion cycle in the internal combustion engine.
